(19) United States
(12) Patent Application Publication
(10) Pub. No.: US 2003/0212587 A1
(43) Pub. Date: Nov. 13, 2003

(54) Apparatus and methods for coordinating Web services using role based interpretation of coordination plans

(75) Inventor: Wilfred C. Jamison, Raleigh, NC (US)

Correspondence Address: Gregory M. Doudnikoff, IBM Corporation T81/503, PO Box 12195, Research Triangle Park, NC, 27709, US

(73) Assignee: International Business Machines Corporation, Armonk, NY (US)

(21) Appl. No.: 10/144,342

(22) Filed: May 13, 2002

(51) Int. Cl. G06F 17/60

(52) U.S. Cl. 705/8

(57) ABSTRACT

An apparatus and method for coordinating web services using a role based interpretation of coordination plans are provided. A primary web service is initiated that requires the collaboration of one or more secondary web services. A coordinator of the primary web service provider identifies a coordination plan for performing the primary web service and determines the roles necessary for completing the primary web service. The coordinator identifies specific secondary web service providers to fill the roles of the coordination plan, from a registry of web service providers. The coordinator then sends a request to the coordinators of these secondary web service providers asking that they participate in the collaboration to achieve the primary web service. If the coordinators of the secondary web service providers accept the invitation to participate in the collaboration, the coordinator of the primary web service provider forwards the coordination plan to the secondary web service providers along with an identification of the secondary web service provider's role in the coordination plan. Thereafter, the primary and secondary web service providers interact with one another and provide their services in accordance with the coordination plan.

### BACKGROUND OF THE INVENTION

1. Technical Field

The present invention is generally directed to coordination of computing devices in a distributed computing environment. More specifically, the present invention is directed to mechanisms for coordinating the operation of various web services in a distributed computing environment using role based interpretation of coordination plans.

2. Description of Related Art

Simple Object Access Protocol (SOAP) and the Extensible Markup Language (XML) are current technologies used in most web services. A “web service” is a web-based application that dynamically interacts with other web applications using open standards. SOAP is a message-based protocol based on XML for accessing services on the World Wide Web.

With known web services, existing web service applications, such as servlets and Enterprise Java Beans (EJBs), can be made to publish their interfaces and be able to process requests from subscribers to those interfaces. This paradigm opened up many opportunities for real business-to-business interactions wherein one business unit can be a service provider and a client to a web service by another business unit at the same time. This facilitated supplier-consumer interaction which will be the basis for real electronic commerce in the very near future as these business entities begin to establish stable interdependencies.

However, the supplier-consumer interaction is not the only interaction experienced in common business transactions. For example, a common business pattern is to divide large projects into their components and subcontract each component to an external business organization. The main issue that arises in this type of work condition is coordination. A collaborative effort, in order to be successful, must be well coordinated. The goal of coordination is to minimize overall latency and overhead caused by redundancy. More importantly, coordination is needed to ensure that the flow of information is accurate in order to achieve the desired outcome.

Coordination is a problem in a distributed system and especially in a heterogeneous environment such as the Internet. The current web services infrastructure lacks the ability to support any form of interaction among business units in which two or more such units collectively work together as a group to accomplish a task or a service. Thus, it would be beneficial to have an apparatus and method for performing collaboration between a plurality of web services.

### SUMMARY OF THE INVENTION

The present invention provides an apparatus and method for-coordinating web services using a mechanism called “role based interpretation of coordination plans”. In an exemplary embodiment of the present invention, web service providers are equipped with coordination mechanisms that perform the functions of the present invention. With the present invention, a primary web service is initiated that requires the collaboration of one or more secondary web services. In this apparatus, each participating web service provider is represented by a special software agent called a “coordinator”. The coordinator of the primary web service provider identifies a coordination plan for performing the primary web service and uses this coordination plan as a means for determining the roles necessary for completing the primary web service. A role is primarily determined by the required service from a web service provider.

Based on the identification of the roles needed, the coordinator of the primary web service provider identifies specific secondary web service providers to fill the roles of the coordination plan. This can be done by consulting a registry of web service providers. The coordinator of the primary web service provider then sends a request to the coordinators of these secondary web service providers asking that they participate in the collaboration to achieve the primary web service.

If the coordinators of the secondary web service providers accept the invitation to participate in the collaboration, the coordinator of the primary web service provider forwards the coordination plan to the coordinators of the secondary web service providers along with an identification of the secondary web service provider's role in the coordination plan. Thereafter, the primary and secondary web service providers interact with one another and provide their services in accordance with the coordination plan.

These and other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram of a distributed computing environment in which the present invention may be implemented;

FIG. 2 is an exemplary block diagram of a server computing device that may provide web services in accordance with the present invention;

FIG. 3 is an exemplary block diagram of a client computing device that may be used to request web services from server computing devices in the distributed computing environment according to the present invention;

FIG. 4 is an exemplary block diagram illustrating a coordination framework for web services in accordance with the present invention;

FIG. 5 is an exemplary diagram illustrating a coordination plan according to the present invention;

FIG. 6 is an exemplary block diagram of a coordinator according to the present invention;

FIG. 7 is a flowchart outlining an exemplary operation of the present invention when initiating coordination between web services in a distributed computing environment;

FIG. 8 is a flowchart outlining an exemplary operation of an initiator of coordination of web services in accordance with the present invention; and

FIG. 9 is a flowchart outlining an exemplary operation of an invitee of an invitation to participate in coordinated web services in accordance with the present invention.

### DETAILED DESCRIPTION OF THE PREFERRED EMBODIMENT

The present invention provides an apparatus and method for coordinating web services using role based interpretation of coordination plans. While the present invention operates in an Internet environment, e.g., the World Wide Web, it should be appreciated that the present invention may be used with any distributed computing environment in which services are provided by separate computing devices and coordination of these services may be necessary. As such, while the exemplary embodiments of the present invention will be described in terms of “web” services, the present invention is not limited to application in the World Wide Web of the Internet.

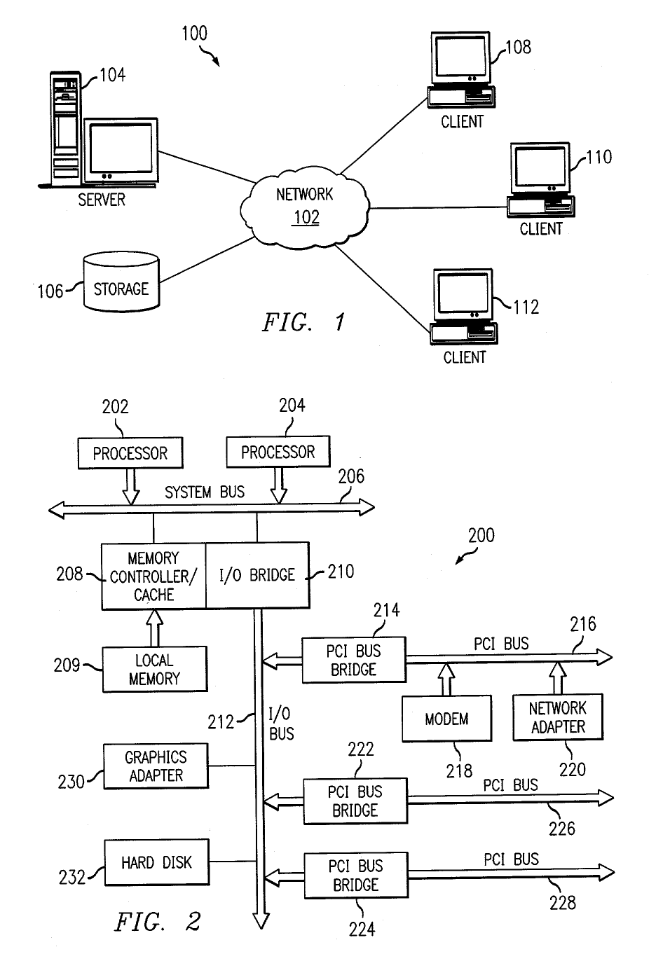

With reference now to the figures, FIG. 1 depicts a pictorial representation of a network of data processing systems, i.e., a distributed computing environment, in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used.

Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards.

In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

As mentioned above, the present invention provides an apparatus and method for coordination of web services using role based interpretation of coordination plans. With the present invention, a primary web service is initiated that makes use of other secondary web services. Such initiation may be at the request of a client device, such as the client device shown in FIG. 3, or may be based on business-to-business communications between server computing devices, such as the server computing device shown in FIG. 2. Because the primary web service that is initiated requires interaction with other secondary web services in order to provide its functionality, a coordination between the primary web service and the secondary web services is necessary.

With the present invention, such coordination is accomplished through role based interpretation of coordination plans. In accordance with one embodiment of the present invention, web service providers are equipped with coordination mechanisms, hereafter referred to as “coordinators,” that perform the functions of the present invention. The coordinator performs the functions of identifying one or more coordination plans for performing the required web service, identifying the roles involved in the web service, identifying web service providers to fill the roles, and interacting with these web service providers to coordinate the web services so as to accomplish the required web service.

With the present invention, a primary web service is initiated that requires the collaboration of one or more secondary web services. A coordinator of the primary web service provider identifies a coordination plan for performing the primary web service and uses this coordination plan as a means for determining the roles necessary for completing the primary web service.

Based on the identification of the roles needed, the coordinator of the primary web service provider identifies specific secondary web service providers to fill the roles of the coordination plan, from a registry of web service providers. The coordinator of the primary web service provider then sends a request to the coordinators of these secondary web service providers asking that they participate in the collaboration to achieve the primary web service.

If the coordinators of the secondary web service providers accept the invitation to participate in the collaboration, the coordinator of the primary web service provider forwards the coordination plan to the coordinators of the secondary web service providers along with an identification of the secondary web service provider's role in the coordination plan. Thereafter, the primary and secondary web service providers interact with one another and provide their services in accordance with the coordination plan.

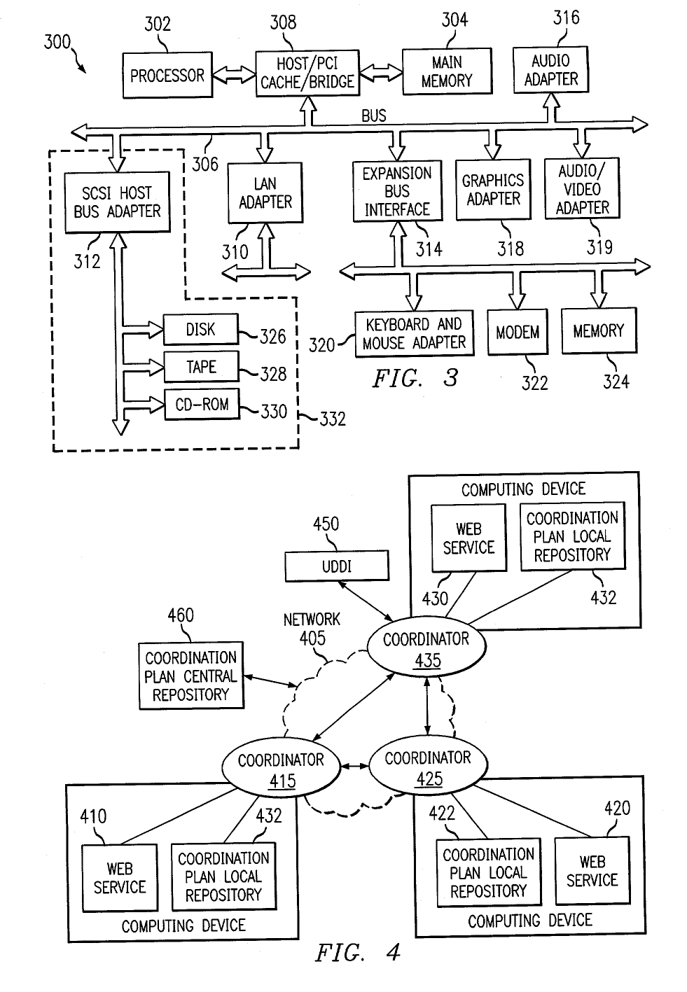

FIG. 4 is an exemplary block diagram illustrating a coordination framework for web services in accordance with the present invention. As shown in FIG. 4, a plurality of web services 410, 420 and 430 are provided by web service provider servers 406-408 that are present in the network 405. While FIG. 4 illustrates each web service provider server providing a single web service, the present invention is not limited to such. Rather, each web service provider server 406-408 may provide one or more web services. Moreover, one or more of the web services used in the collaboration described hereafter may be present on the same web service provider server 406-408 without departing from the spirit and scope of the present invention.

In the particular example shown, web service 430 is a primary web service that invokes collaboration from the other web services 410 and 420, as described hereafter. The primary web service 430 is initiated, for example, in response to a request for the web service 430. This request may come from, for example, a client device, such as a user's personal computer, a server device, such as a business enterprise's server computer, another web service provider server 406-408, or the like.

Upon initiating the primary web service 430, the coordinator 435 associated with the web service provider server 406 identifies a coordination plan to be used in providing the primary web service 430. The identification of the coordination plan may be based on, for example, a lookup table of coordination plans, meta data associated with the web service 430 that identifies the coordination plan, a service lookup in a services directory that identifies the service and its associated coordination plan, and the like. The method to identify the coordination plan that can be used most immediately by businesses is to have simple local directory of coordination plans based on the collaborative service requested by or as a result of a request by a client. Another possibility is for the client to directly provide the coordination plan to the primary web service.

The coordination plan is data identifying the services needed to complete the primary web service, the type of interactions required between the services, and the conditions under which these interactions occur. The coordination plan is described in terms of roles in which a role defines the service it provides without binding to any specific service provider, when the role is needed in the collaboration, how the role should interact with other roles identified in the coordination plan, and actions to take in the event or an error in order to provide error recovery. By assigning a web service to a particular role in the coordination plan, the web service can operate independently and with sufficient information to know when to communicate with the other web services in the collaboration.

Upon identifying a coordination plan to be used in providing the primary web service 430, the coordinator 435 determines if the coordination plan is stored in a local coordination plan repository 432. If not, the coordination plan is retrieved from a remotely located central coordination plan repository 460. The central coordination plan repository 460 is a storage system to which coordinators may publish coordination plans for various web services. The central coordination plan repository 460 may be a separate system from the UDDI 450, described hereafter, or may be incorporated with the UDDI 450. Furthermore, the central coordination plan repository 460 may be utilized, in the event that a coordination plan is not identified for a primary web service in the manner discussed above, to locate a coordination plan for the primary web service that may have been published by another web service provider.

Having obtained the coordination plan, the coordinator 435 determines if collaboration by other web services is required to perform the primary web service 430. In other words, the coordinator 435 determines if there is more than one role in the coordination plan and whether those roles need to be performed by different web services. If a single role is present in the coordination plan, the coordinator 435 determines if the role can be performed by a local web service, e.g., web service 430, or must be performed using a remotely located web service.

If there is more than one role in the coordination plan, or in the case of a single role in the coordination plan, the local web service cannot fill the role identified in the coordination plan, then collaboration with other web service provider servers 407-408 is necessary. Upon a determination that collaboration is necessary, the coordinator 435 performs a service lookup using the Universal Description, Discovery and Integration (UDDI) service 450 to identify web service provider servers 407-408 that provide the services necessary in the collaboration defined by the roles in the coordination plan.

UDDI is an industry initiative for a universal business registry or catalog of web services. UDDI is designed to enable software to automatically discover and integrate with services on the World Wide Web. UDDI contains white pages (addresses and contacts), yellow pages (industry classification) and green pages (description of services). The green pages include the XML version, type of encryption and a Document Type Definition (DTD) of the standard. UDDI messages ride on top of the SOAP protocol, which invokes services on the web.

The UDDI 450 according to the present invention may be the same UDDI generally known in the art. However, in an alternative embodiment, the UDDI 450 is modified to include information identifying whether particular web service providers are “collaboration ready.” By “collaboration ready” what is meant is that the web service provider server is equipped with a coordinator that makes use of coordination plans in accordance with the present invention. This designation of “collaboration ready” or not being “collaboration ready” may be a mechanism for initially filtering out results of the UDDI lookup to only include those web service providers with which collaboration may be performed.

It is conceivable that the UDDI lookup may result in a plurality of web service providers that provide the services necessary to perform the collaboration defined by the coordination plan and are collaboration ready. The coordinator 435 may be provided with selection algorithms for selecting web service providers from the list of web service providers retrieved from the UDDI 450. In an alternative embodiment, invitations to engage in collaboration may be sent to all of the possible web service providers with the first positive response for each role in the coordination plan being accepted and all others being ignored. In another embodiment, the selection algorithm may generate a prioritized list of these web service providers such that, in the event that a web service provider refuses an invitation to enter into collaboration, an invitation may be sent to the next web service provider in the prioritized list.

Having identified web service providers for providing the services necessary to fill the roles of the coordination plan, the coordinator 435 issues invitation messages to the coordinators 415 and 425 of the identified web service provider servers 407-408 and awaits a response. The coordinators of the web service provider servers 406-408 communicate with each other via message headers, such as SOAP message headers. The coordinators act as “interpreters” of the coordination plan and the message headers of messages received by the coordinators. Depending on the message written in the message header, a coordinator may forward a received message to the web service provider server or operate on the message itself. That is, the message is either addressed to the web services or to the coordinator itself. In the latter case, the are many possibilities for processing of the message which include the coordinator using information for computation, or modifying values and then forwarding the results either to the sender or to other coordinators, the coordinator can also collect results from other coordinators, and the like. The message may be also be an explicit coordination protocol/instruction such as telling the receiver to wait until a go-signal is received later, or a signal to join a group, etc.

Likewise, the web service provider server may send messages via the coordinator which may add header messages before forwarding the message to the target coordinator. In this way, the coordinators of the various web service providers communicate with one another via headers.

If, in response to receipt of the invitation to engage in collaboration, a coordinator of a web service provider returns a refusal message indicating that the coordinator does not accept the invitation, or if the invitation times out, the coordinator 435 may issue the invitation message to another web service provider server that provides the service required to fulfill the role in the coordination plan. This may be done for each role identified in the coordination plan.

For each web service provider server 407-408 that agrees to the collaboration invitation sent by the coordinator 435, the coordinator 435 sends a copy of the coordination plan along with an identification of the role in the coordination plan that is to be assumed by the web service provider server. Thereafter, messaging and data transfer between the web services is governed by the coordinators of the web service providers under the terms of the coordination plan.

The collaboration messages, in a preferred embodiment, are implemented as SOAP messages with appropriate collaboration headers, tags, and the like. The following is an example SOAP message embedded on HTTP from an initiating coordinator to a prospective member of a collaboration group:

POST /WSCoordination HTTP/1.1
Host: www.abcmerchant.com
Content-Type: text/xml; charset=“utf-8”
Content-Length: nnnn
SOAPAction: “Some-URI”
<SOAP-ENV: Envelope
xmlns:SOAP-
ENV=“http://schemas.xmlsoap.org/soap/envelope/”
SOAP-
ENV:encodingStyle=“http://schemas.xmlsoap.org/soap/encoding/”/>

<SOAP-ENV:Header>

<rfc:Collaboration xmlns:rfcz=“some-URI”
SOAP-ENV mustUnderstand=“1”>

RFC

</rfc:Collaboration>

</SOAP-ENV:Header>
<SOAP-ENV:Body>

<cp:CoordinationPlan xmlns:cp=“Some-URI”>
<script>BiddingScript</script>
<location>Some-URI</location>
<service-needed>Merchandising</service-needed>
<role-requested>Bidder</role-requested>
<response-required>immediately</ response-required>
</cp:CoordinationPlan>

</SOAP-ENV:Body>

</SOAP-ENV:Envelope>

The SOAP header of the above example message indicates to the recipient that this message is for a collaboration between the coordinators. The receiver must understand the message and process it. The tag <action> indicates the value RFC (Request for Collaboration) which means that the sender is requesting the recipient to participate in the collaboration. The tag also indicates that the receiver must respond immediately, which may mean within a predetermined time period of sending of the SOAP message.

In the body of the message is a description of the coordination script or plan to be used in the collaboration. The <location> tag tells the recipient where it can obtain a copy of the script. The <service-needed> tag indicates what kind of service is expected from the recipient. The <role-requested> tag is the role being requested that the recipient assume based on the coordination script. Note that there can be multiple roles that can be requested of the recipient.

The following is an example of a positive response message from a recipient or invitee that receives the invitation SOAP message described above:

POST /WSCoordination HTTP/1.1
Host: www.xyzauction.com
Content-Type: text/xml; charset=“utf-8”
Content-Length: nnnn
SOAPAction: “Some-URI”
<SOAP-ENV: Envelope
xmlns:SOAP-
ENV=“http://schemas.xmlsoap.org/soap/envelope/”
SOAP-
ENV:encodingStyle=“http://schemas.xmlsoap.org/soap/encoding/”/>

<SOAP-ENV:Header>

<rfc:Collaboration xmlns:rfc=“some-URI”
SOAP-ENV:mustUnderstand=“1”>

RRFC

</rfc:Collaboration>

</SOAP-ENV:Header>
<SOAP-ENV:Body>

<cp:CoordinationPlan xmlns:Cp=“Some-URI”>

<script>BiddingScript</script>
<location>Some-URI</location>
<service-needed>Merchandising</service-needed>
<role-requested>Bidder</role-requested>
<response>Yes</response>

</cp:CoordinationPlan>

</SOAP-ENV:Body>

</SOAP-ENV:Envelope>

Note that the body of the SOAP response message contains the original body sent by the initiator in the invitation message.

Once the initiator receives all the responses from the invited coordinators and, assuming that all roles in the coordination script are satisfied by positive responses from coordinators, the initiator sends another SOAP message to each coordinator to acknowledge the responses. This message also serves to indicate that the collaboration effort should now commence. An example of this acknowledgment message follows:

POST /WSCoordination HTTP/1.1
Host: www.abcmerchant.com
Content-Type: text/xml; charset=“utf-8”
Content-Length: nnnn
SOAPAction: “Some-URI”
<SOAP-ENV:Envelope
xmlns:SOAP-
ENV=“http://schemas.xmlsoap.org/soap/envelope/” SOAP-
ENV:encodingStyle=“http://schemas.xmlsoap.org/soap/encoding/”/>

<SOAP-ENV:Header>

<rfc:Collaboration xmlns:rfc=“some-URI”
SOAP-ENV:mustUnderstand=“1”>

COMMENCE

</rfc:Collaboration>

</SOAP-ENV:Header>
<SOAP-ENV:Body>

<cp:CoordinationPlan xmlns:cp=“Some-URI”>
<role>Bidder</role>
<script>“Some-XML document” </script>
</cp:CoordinationPlan>

</SOAP-ENV:Body>

</SOAP-ENV:Envelope>

Note that under the body of the message, the tag <script> is an embedded XML document that corresponds to the coordination plan that must be interpreted by the recipient. A formal description of coordination plans and an example are given below.

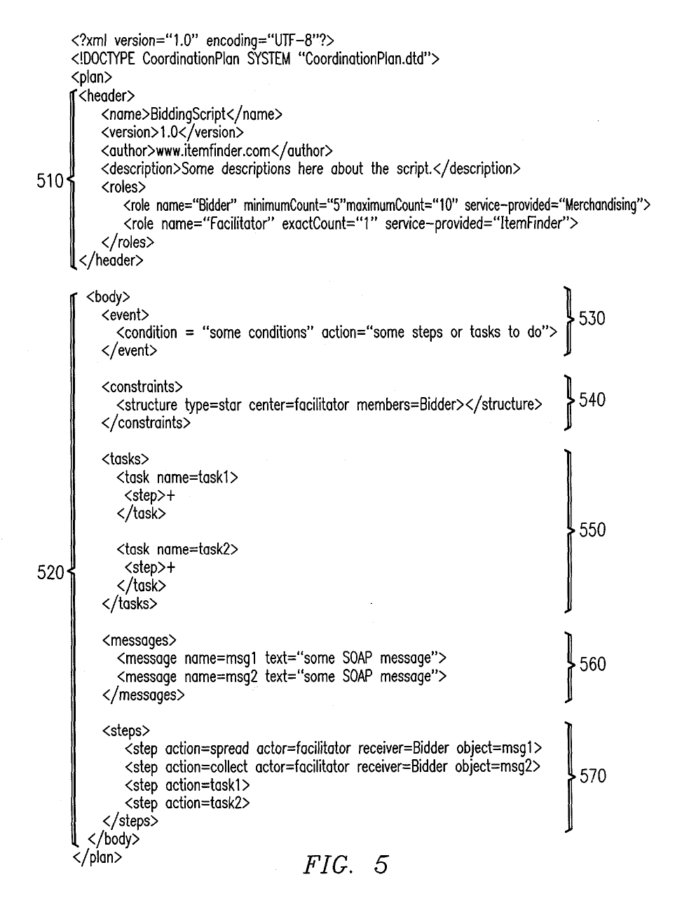

FIG. 5 is an exemplary diagram illustrating a coordination plan according to the present invention. A coordination plan is composed of a header and a sequence of steps that must be carried out by the interpreter of the coordination plan. A step defines an action that must be carried out by an actor optionally over a given object. The result or object of such action may be passed on to a specified receiver. The action can be further clarified with specific directives. A step is composed of the follow:

1. Action—specifies the specific task that needs to be accomplished;

2. Actor—specifies who carries out the specified action;

3. Object—specifies the data or actor used in carrying out the action;

4. Receiver—specifies the target recipient of the result or object of the action (not all steps have receivers);

5. Directive—specifies other information to further qualify the description of the action.

The coordination logic is embedded in each of the actions as part of their semantics. Thus, when a coordinator interprets an action, it knows exactly what to do if the action requires some coordination activities.

Referring again to FIG. 5, the coordination plan header 510 gives the name of the coordination plan, a description, the roles that are involved in the plan and the corresponding services required of each role. The syntax for specifying steps can be defined to be any type of syntax as long as the semantics are properly followed and implemented by the interpreters. For example, the coordination plan can be expressed as an XML document where elements of the document can pertain to steps that constitute the coordination plan. Thus, while coordinators exchange SOAP messages, they may interpret coordination plans written as XML documents.

The body 520 of the coordination plan consists of several elements including events 530, constraints 540, tasks 550, messages 560, and steps 570. Events 530 are condition-action pairs. Each condition describes some kind of state which the coordinator must monitor. If the condition is satisfied, the action is executed. An action is composed of steps.

Constraints 540 are imposed upon the coordinators. In the example shown in FIG. 5, the structure constraint specifies that the facilitator and bidders form a star configuration that defines the communication links. This means that bidders are only allowed to talk with the facilitator. Any type of constraint may be used without departing from the spirit and scope of the present invention.

Tasks 550 are groups of steps. By grouping steps into tasks 550, the group of steps may be called as a whole. Messages 560 is a list of all possible static SOAP messages that can be passed between coordinators. They are used as objects in a step.

Steps 570 is a sequence of steps. The interpretation of the coordination plan starts with interpreting the steps. Thus, in the depicted example, the spread action is the very first step that will be interpreted. In a role-based interpretation, if the role assigned to a coordinator is the “facilitator,” then he becomes the actor in this step and performs the spread action. The spread action involves spreading the message object to all the receivers. If a coordinator's role is bidder, then the coordinator waits until the message is received from the facilitator. Thus, there is an implicit coordination being done just by interpreting the spread action. Of course, any number of different steps can be used and combined to generate a coordination plan without departing from the spirit and scope of the present invention.

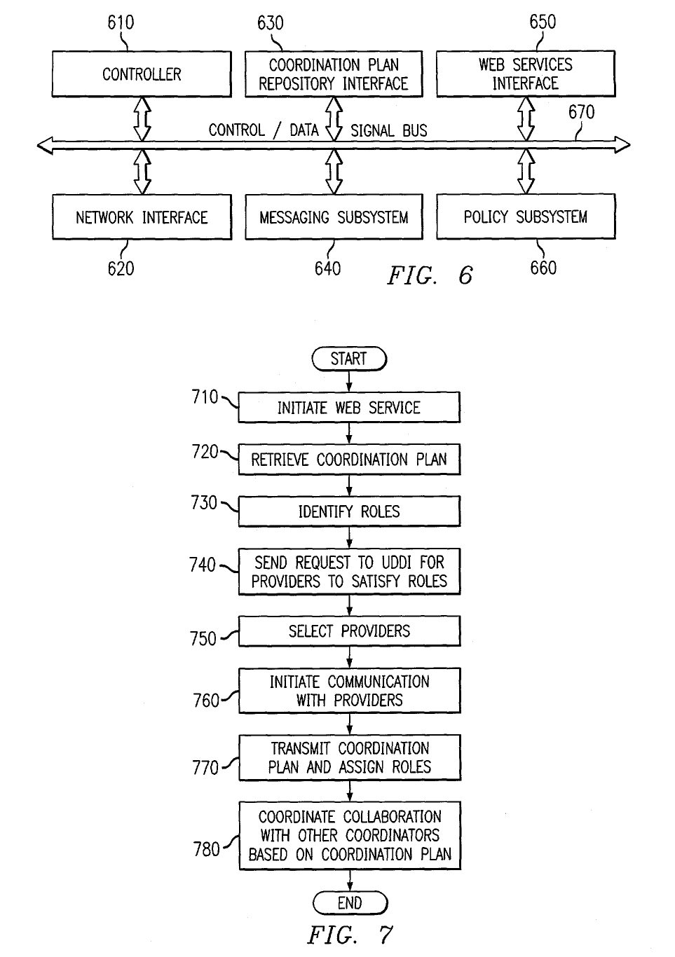

FIG. 6 is an exemplary block diagram of a coordinator according to the present invention. The elements shown in FIG. 6 may be implemented as hardware, software, or a combination of hardware and software. In a preferred embodiment, the elements of FIG. 6 are implemented as software instructions executed by one or more hardware elements. Any combination of hardware and/or software may be used without departing from the spirit and scope of the present invention.

The coordinator may be part of the web service provider server or may be part of a separate device from the web service provider server. The coordinator may be incorporated into the electronic business system of web service provider server as a module between the messaging interface and business logic, for example. Alternatively, the coordinator may be part of a proxy, communication provider, or the like, through which the web service provider server communicates over the network.

As shown in FIG. 6, the coordinator includes a controller 610, a network interface 620, a coordination plan repository interface 630, a messaging subsystem 640, a web services interface 650 and a policy subsystem 660. The elements 610-660 are in communication with one another via the control/data signal bus 670. Although a bus architecture is shown in FIG. 6, the present invention is not limited to such and any architecture that facilitates the communication of control/data signals between the elements 610-660 may be used without departing from the spirit and scope of the present invention.

The controller 610 controls the overall operation of the coordinator 610 and orchestrates the operation of the other elements 620-660. The controller 610 sends messages to other coordinators and receives messages from other coordinators through the network interface 620. The controller 610 communicates with the web services of the web service provider server via the web services interface 650.

The coordination plan repository interface 630 provides an interface through which the controller 610 may obtain access to locally stored coordination plans. The messaging subsystem 640 is used to generate messages and parse received messages under the protocol set forth by the coordination plan implemented by the controller 610. The policy subsystem 660 executes the business policies for the web services and provides a mechanism through which these web services are controlled based on business policies established by the human administrators. The coordination framework of the present invention is independent of the policy used by each web service in determining how they are going to respond to invitations and messages. The business policies may operate in many different ways and thus, the present invention is not limited to any particular type of business policy. Suffice it to say that the policy subsystem 660 is the business side processes that operate to perform the business functions with regard to interactions with other computing systems. For example, the business policies implemented by the policy subsystem 660 provides the decision-making mechanism for accepting or denying requests from and issuing requests to other computing systems.

In an exemplary operation, the controller 610 receives a request for a primary web service via the network interface 620. The controller 610 identifies a coordination plan associated with the requested primary web service and retrieves the coordination plan either from a local repository through coordination plan repository interface 630 or from a remote repository through network interface 620. The identification of the coordination plan may be based on a table lookup in a coordination plan table stored in an associated memory (not shown), for example.

The controller 610 then identifies the roles in the coordination plan and sends a request to a registry, such as UDDI, requesting web service providers that provide web services that meet the roles of the coordination plan. The controller 610 then selects one or more web service providers from the web service provider list obtained from the registry and instructs the messaging subsystem 640 to transmit an invitation message to the coordinators of the other web service providers.

The controllers of the other coordinators receive the invitation message and provide the invitation message to the policy subsystem 660 which determines whether to accept the invitation. If so, an acceptance message is returned to the inviting coordinator.

In the inviting coordinator, the controller 610 receives the acceptance message, assigns a role to the accepting coordinator's associated web service, and transmits a copy of the coordination plan and the identification of the role to the accepting coordinator. Alternatively, an identification of the coordination plan may be transmitted and the accepting coordinator may search for the coordination plan in a local or remote repository.

The controller 610, once all other roles in the coordination plan are filled, may then operate under the coordination plan to provide the requested web service. Such operation may include initiated one or more local web services via the web services interface 650.

FIG. 7 is a flowchart outlining an exemplary operation of the present invention when initiating coordination between web services in a distributed computing environment. As shown in FIG. 7, the operation starts with initiating a primary web service (step 710). The coordination plan for the primary web service is then retrieved (step 720) and the roles in the coordination plan are identified (step 730).

A request is sent to the UDDI for providers to satisfy the identified roles (step 740). The providers are then selected (step 750) from the list received from the UDDI and communication with the selected providers is initiated (step 760). Such initiation involves sending an invitation to the selected providers and obtaining their acceptance of the invitation. If the providers reject the invitation, other providers may be selected to fill the roles of the coordination plan.

Thereafter, the coordination plan and a role assignment is sent to each of the accepting providers (step 770). The collaboration between the coordinators of the providers is then coordinated using the coordination plan (step 780).

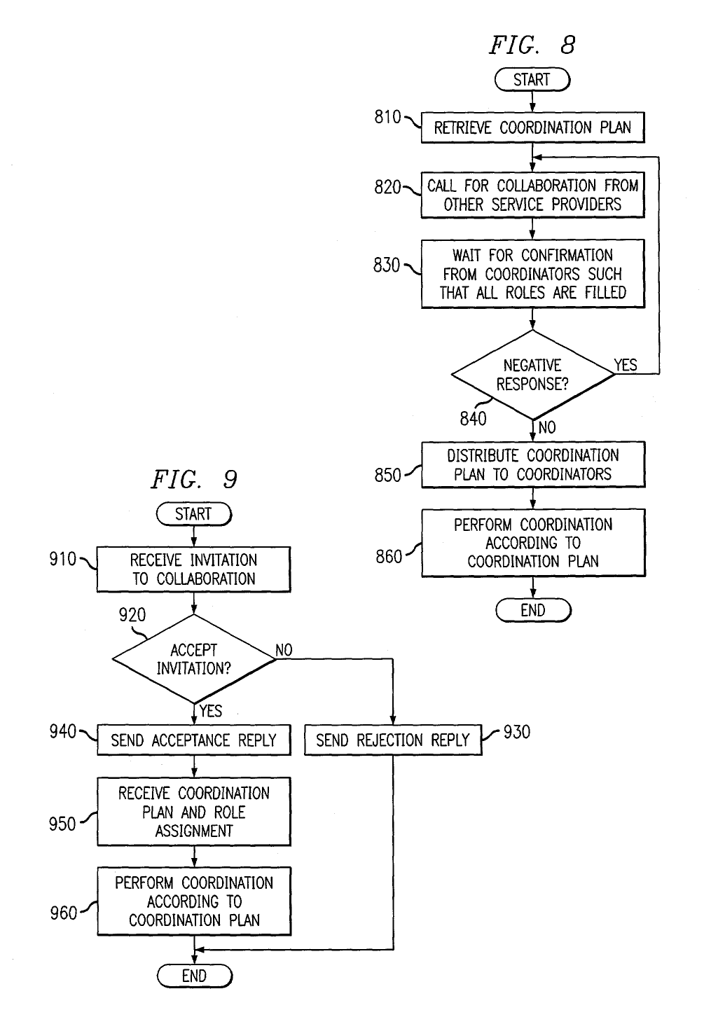

FIG. 8 is a flowchart outlining an exemplary operation of an initiator of coordination of web services in accordance with the present invention. As shown in FIG. 8, a coordination plan is retrieved (step 810) and a call for collaboration is sent to the coordinators of the other service providers that are to be part of the collaboration (step 820). The calling coordinator then waits for confirmation from the coordinators of the other service providers such that all of the roles are filled (step 830). If a negative response is received (step 840) from a service provider, the operation returns to step 820 where a different service provider is invited to join the collaboration.

Otherwise, if all of the roles of the coordination plan are filled, the coordination plan is distributed to the other coordinators along with a role assignment (step 850). Collaboration is then performed (step 860).

FIG. 9 is a flowchart outlining an exemplary operation of an invitee of an invitation to participate in coordinated web services in accordance with the present invention. As shown in FIG. 9, the operation starts with receiving an invitation to engage in collaboration (step 910). A determination is made as to whether or not to accept the invitation (step 920). If not, a rejection reply is sent (step 930) and the operation terminates. If the invitation is accepted, an acceptance reply is sent (step 940) and the coordination script along with a role assignment is received (step 950). Collaboration is then performed based on the coordination plan (step 960).

Thus, the present invention provides an apparatus and method for web services to collaborate with one another to perform a primary web service. Once the collaboration is started, the coordination according to the present invention is not centralized, that is, there is no master coordinator. Coordination is dictated mainly by interpreting the coordination script individually by each coordinator. Interpretation of the same script varies depending on which role the coordinator was given. One main feature of this invention is that coordination scripts are not tied to any specific web service provider. As a result, each web service provider may operate independently of the others under the same general guidelines provided in the coordination plan or collaboration script.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of providing a primary web service, comprising:
identifying a coordination plan for the primary web service, wherein the coordination plan identifies a first web service and a second web service to be used to provide the primary web service;
identifying at least one first provider of the first web service and at least one second provider of the second web service;
forwarding the coordination plan to the at least one first and second providers; and
coordinating collaboration between the first and second web services based on the coordination plan.

2. The method of claim 1, further comprising:
transmitting an invitation to engage in collaboration to the at least one first provider and the at least one second provider; and
receiving responses from the at-least one first provider and the at least one second provider.

3. The method of claim 2, wherein if a response from the at least one first provider is negative, the method further comprises:
identifying at least one third provider of a web service corresponding to the first web service provided by at least one first provider.

4. The method of claim 2, wherein the invitation includes at least one role designation for the at least one first provider or the at least one second provider.

5. The method of claim 2, wherein the invitation includes an identification of a location where the coordination plan is available.

6. The method of claim 1, wherein coordinating collaboration between the first and second web services based on the coordination plan includes performing role based interpretation of the coordination plan.

7. The method of claim 6, wherein each of the at least one first provider and the at least one second provider include a coordinator, and wherein performing role based interpretation of the coordination plan includes the coordinator for a provider interpreting the coordination plan based on a role assigned to the provider.

8. The method of claim 1, wherein identifying at least one first provider of the first web service and at least one second provider of the second web service includes performing a lookup of providers in a web service provider registry.

9. The method of claim 1, wherein identifying a coordination plan for the primary web service includes using one of a lookup table of coordination plans, meta data associated with the primary web service that identifies the coordination plan, and a service lookup in a services directory that identifies the primary web service and its associated coordination plan.

10. The method of claim 1, further comprising:
retrieving the coordination plan from one of a local coordination plan repository and a remotely located central coordination plan repository.

11. The method of claim 1, wherein identifying at least one first provider of the first web service and at least one second provider of the second web service includes:
identifying a set of first providers;
identifying a set of second providers; and
selecting a portion of the set of first providers and a portion of the set of second providers to form the at least one first provider and the at least one second provider.

12. The method of claim 11, wherein selecting a portion of the set of first providers and the set of second providers includes sending an invitation to collaborate to each provider in the set of first providers and each provider in the set of second providers and selecting providers based on the first providers from each set that return a positive response.

13. The method of claim 11, wherein selecting a portion of the set of first providers and the set of second providers includes generating a prioritized list of providers in the set of first providers and the set of second providers.

14. The method of claim 1, wherein the coordination plan includes an identification of one or more actions that specify specific tasks that are to be accomplished, an identification of one or more actors that are to carry out the specified one or more actions, and an identification of objects that specify the data or actors used in carrying out the one or more actions.

15. The method of claim 1, wherein the coordination plan includes a header that identifies the roles involved in the coordination plan and the services required for each role.

16. A computer program product in a computer readable medium for providing a primary web service, comprising:
first instructions for identifying a coordination plan for the primary web service, wherein the coordination plan identifies a first web service and a second web service to be used to provide the primary web service;
second instructions for identifying at least one first provider of the first web service and at least one second provider of the second web service;
third instructions for forwarding the coordination plan to the at least one first and second providers; and
fourth instructions for coordinating collaboration between the first and second web services based on the coordination plan.

17. The computer program product of claim 16, further comprising:
fifth instructions for transmitting an invitation to engage in collaboration to the at least one first provider and the at least one second provider; and
sixth instructions for receiving responses from the at least one first provider and the at least one second provider.

18. The computer program product of claim 17, wherein if a response from the at least one first provider is negative, the computer program product further comprises:
seventh instructions for identifying at least one third provider of a web service corresponding to the first web service provided by at least one first provider.

19. The computer program product of claim 17, wherein the invitation includes at least one role designation for the at least one first provider or the at least one second provider.

20. The computer program product of claim 17, wherein the invitation includes an identification of a location where the coordination plan is available.

21. The computer program product of claim 16, wherein the fourth instructions for coordinating collaboration between the first and second web services based on the coordination plan include instructions for performing role based interpretation of the coordination plan.

22. The computer program product of claim 21, wherein each of the at least one first provider and the at least one second provider include a coordinator, and wherein the instructions for performing role based interpretation of the coordination plan includes instructions for the coordinator for a provider interpreting the coordination plan based on a role assigned to the provider.

23. The computer program product of claim 16, wherein the second instructions for identifying at least one first provider of the first web service and at least one second provider of the second web service include instructions for performing a lookup of providers in a web service provider registry.

24. The computer program product of claim 16, wherein the first instructions for identifying a coordination plan for the primary web service include instructions for using one of a lookup table of coordination plans, meta data associated with the primary web service that identifies the coordination plan, and a service lookup in a services directory that identifies the primary web service and its associated coordination plan.

25. The computer program product of claim 16, further comprising:
fifth instructions for retrieving the coordination plan from one of a local coordination plan repository and a remotely located central coordination plan repository.

26. The computer program product of claim 16, wherein the second instructions for identifying at least one first provider of the first web service and at least one second provider of the second web service include:
instructions for identifying a set of first providers;
instructions for identifying a set of second providers; and
instructions for selecting a portion of the set of first providers and a portion of the set of second providers to form the at least one first provider and the at least one second provider.

27. The computer program product of claim 26, wherein the instructions for selecting a portion of the set of first providers and the set of second providers include instructions for sending an invitation to collaborate to each provider in the set of first providers and each provider in the set of second providers and instructions for selecting providers based on the first providers from each set that return a positive response.

28. The computer program product of claim 26, wherein the instructions for selecting a portion of the set of first providers and the set of second providers include instructions for generating a prioritized list of providers in the set of first providers and the set of second providers.

29. The computer program product of claim 16, wherein the coordination plan includes an identification of one or more actions that specify specific tasks that are to be accomplished, an identification of one or more actors that are to carry out the specified one or more actions, and an identification of objects that specify the data or actors used in carrying out the one or more actions.

30. The computer program product of claim 16, wherein the coordination plan includes a header that identifies the roles involved in the coordination plan and the services required for each role.

31. An apparatus for providing a primary web service, comprising:
means for identifying a coordination plan for the primary web service, wherein the coordination plan identifies a first web service and a second web service to be used to provide the primary web service;
means for identifying at least one first provider of the first web service and at least one second provider of the second web service;
means for forwarding the coordination plan to the at least one first and second providers; and
means for coordinating collaboration between the first and second web services based on the coordination plan.
